(19) United States
(12) Patent Application Publication
(10) Pub. No.: US 2016/0301748 A1
(43) Pub. Date: Oct. 13, 2016

(54) METHOD AND SYSTEM FOR CONSUMING SYNCHRONIZED DIGITAL CONTENT AMONG A PLURALITY OF USERS OVER A NETWORK

(71) Applicants: John Joseph Conley, Saratoga Springs, NY (US); Maeve Frances CONLEY, Saratoga Springs, NY (US)

(72) Inventors: John Joseph Conley, Saratoga Springs, NY (US); Maeve Frances CONLEY, Saratoga Springs, NY (US)

(21) Appl. No.: 14/994,442

(22) Filed: Jan. 13, 2016

Related U.S. Application Data
(60) Provisional application No. 62/102,756, filed on Jan. 13, 2015.

(51) Int. Cl. H04L 29/08; H04L 29/06

(52) U.S. Cl. CPC H04L 67/1095; H04L 65/403; H04L 65/1069

(57) ABSTRACT

A method, system, technique, and computer program product for consuming digital content among a plurality of users, including selecting the digital content to be consumed; establishing a social interaction tool among the users over a computer network; and each user of the plurality of users consuming the selected digital content from a respective digital content stream source in substantial synchronicity over the network, including interacting with other users using the social interaction tool. This may include controlling the selected digital content from each content stream source, including synchronizing the consumption of said selected digital content among the plurality of users.

### RELATED APPLICATION INFORMATION

This United States non-provisional patent application claims the benefit of U.S. provisional patent application Ser. No. 62/102,756, filed Jan. 13, 2015, which is hereby incorporated herein by reference in its entirety.

### TECHNICAL FIELD

The present invention relates to coordinating and synchronizing the consumption of digital content over a network between multiple users, including using a social interaction tool.

### BACKGROUND OF THE INVENTION

Conventional communication between consumers of digital content involves the cumbersome process of using existing social interaction tools while viewing content that is individually controlled by each user, or simply “broadcast” by a central content source (e.g., a TV station).

The present invention addresses these problems, by providing a method, system, technique, and computer program for consuming synchronized digital content among a plurality of users over a network, including using a social interaction tool while consuming the digital content.

### SUMMARY OF THE INVENTION

The shortcomings of the prior art are addressed, and additional advantages are provided by the present invention which in one aspect is a method, system, technique, and computer program product (occasionally referred to herein without limitation as LiveTime) for consuming digital content among a plurality of users, including the plurality of users selecting the digital content to be consumed; establishing a social interaction tool among the users over a computer network; and each user of the plurality of users consuming the selected digital content from a respective digital content stream source in substantial synchronicity over the network, including interacting with other users using the social interaction tool. This may include controlling the selected digital content from each content stream source, including synchronizing the consumption of said selected digital content among the plurality of users.

Another aspect may include coordinating the plurality of users in a calendar to schedule said consuming of the selected digital content.

The plurality of users may be initially established using a network friends list and/or searching users on the computer network and/or identifying users from the computer network using compatibility criteria.

The users may issue reviews of the selected digital content after consuming the content.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter regarded as the invention is particularly pointed out and distinctly claimed at the conclusion of the specification. The foregoing and other objects, features, and advantages of the invention are apparent from the following detailed description taken in combination with the accompanying drawings in which:

FIG. 1 is a high-level flowchart in accordance with one aspect of the present invention;

FIG. 2 is an exemplary flow diagram for account management in accordance with an aspect of the present invention;

FIG. 3 is an exemplary flow diagram for watching a show in accordance with an aspect of the present invention;

FIG. 4 is an exemplary flow diagram for “friends synchronize controls & social interaction tools,” in accordance with an aspect of the present invention;

FIG. 5 is an exemplary data structure and flow diagram showing a user device, server, and the internet, in accordance with an aspect of the present invention; and

FIGS. 6-12 are exemplary screen displays, in accordance with aspects of the present invention.

### DETAILED DESCRIPTION OF THE INVENTION

The present invention (occasionally referred to herein without limitation as LiveTime) in one embodiment is an application enabling the socialization of Internet content (e.g., video) streaming including live television programming. The application may use video content streaming services, for example and without limitation, Netflix, Amazon Prime, Hulu Plus and HBOGO, connecting people separated by distance but not spirit; and live television programming with a focus on sporting events and large scale popular culture events.

LiveTime may operate from the user's device, e.g., a computer, laptop or tablet. When desired by the user, the device can be connected to the television via, e.g., a blue-tooth or Wi-Fi enabled connection device (“LiveTime CONNECT”).

### Description Of Exemplary Embodiments Of The Present Invention:

LiveTime—STREAMING

LiveTime—STREAMING synchronizes streaming video between users (“Friends”) in different locations allowing two or more people to virtually watch a video, movie, or a TV show together including typed or audible commentary from either party with an option for a picture-in-picture visual connection. It is adaptable for laptops, desktops, tablets, Smart TVs and TVs. The streamed video can be paused, fast forwarded or rewound by any Friend at the same time. All Friends would remain at the same point during the movie/show.

LiveTime may not provide video content but instead may partner with video streaming services including Netflix, Amazon Prime, HULU and HBOGO creating the social element of streaming services that already available. In this case, LiveTime verifies membership in each provider service prior to allowing Friends to connect and view that provider's streaming content, Single Point Login. After verifying membership, LiveTime synchronies the control panels to all FRIENDS.

LiveTime—TV

Similar to LiveTime Streaming, LiveTime—TV allows two or more people to—virtually watch a video, movie, or a TV show together including typed or audible commentary from either party with an option for a picture-in-picture visual connection. The LiveTime—TV requires the use of the LiveTime CONNECT—a plug-in device for your TV that transmits you and your Friends commentary or video onto the TV screen. LiveTime E—TV uses a television's built in closed captioning feed to display running commentary between FRIENDS, LiveTime TICKER, and PIP function to provide video connection,

LiveTime—SPORTS

LiveTime—SPORTS is the commercialization of the LiveTime for sporting events in public venues or sports bars. LiveTime—SPORTS requires the use of the LiveTime CONSOLE in addition to the LiveTime CONNECT. The LiveTime CONSOLE is located at multiple locations in the public venue, for example at each table in a sports bar. The console acts as your tablet or computer in LiveTime Streaming and LiveTime—TV, by connecting to the LiveTime CONNECT on the TV. Individuals can then login for a team to provide and read commentary of other fans throughout the country.

LiveTime SOCIAL INTERACTION TOOL FEATURES

To enhance the LiveTime social experience, each Friend may activate their account by inputting setup parameters, for example:
Each user would create a username and signup profile to facilitate the search function.
A link/invitation function coordinated with acceptance by both parties allows the development of a Friend's list.
Each user can setup various watch groups i.e. family, friends . . . allowing LiveTime viewing invitations to go out to individuals or selected groups.
“Watch lists” function that maintains a listing of your preferred viewing choices. This Watch List is a split screen showing the movie or show on one side and a list of Friends that have a similar interest in the movie or show in the other side of the screen.
History function that maintains the list of movies or shows watched.

The social features of LiveTime may include the following:
The ability to recommend a movie or program to other Friends.
A master schedule used to select movie times, invite Friends, and recommend watch lists.
The ability to write a review that would be available to your Friend list. This acts as another way to find quality content and share the experience with friends.
Reviews are aggregated giving the movie or show an Overall User Rating and A Friends rating.
Option of locked commentary, in which you could make your comments locked to a particular moment of a video so when friends (or segments of your friend list) view this video they can view your thoughts on it as well.

Revenue Sources

LiveTime includes multiple revenue sources that include:
The home page includes trailer review, either promoted or searchable.
Home page product advertising based on user preferences/search history/location.
Direct advertising only allowed on the home page, no application interruption during video streaming for LiveTime STREAMING.
Direct advertising on the laptop or LIVETIME CONSOLE during TV breaks for LiveTime TV and LiveTime SPORTS.
Sponsored content, for example, the promotion social media events or small indie movies to gain exposure or self-promotion.

LIKELY USERS
One group of likely users of LiveTime include high school and college students. People away from friends, familiar with technology, and looking to connect, but not with everyone.
Another group of likely users is sports fans, initially on an individual basis through the home similar to LiveTime STREAMING, but with live TV sports shows, LiveTime—TV.
Another group of likely users is young sports fans, using the LiveTime CONSOLE at local sports bars and pubs. Imagine connecting a pub in Dallas with one in New York for a Giants-Cowboys game. The target product for these groups is LiveTime SPORTS.

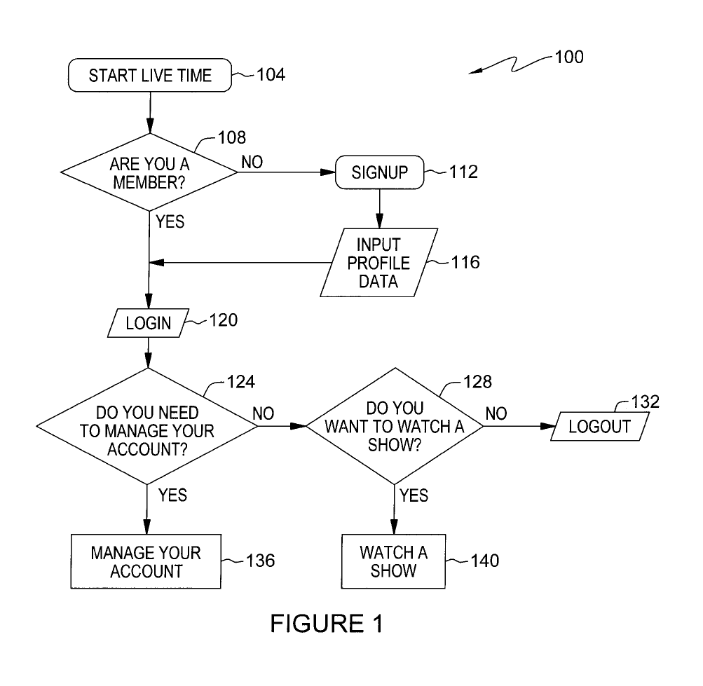

With reference to FIG. 1, a high-level flow diagram 100 in accordance with one aspect of the present invention, the elements of the flow diagram may be described as follows:

104—Start Live Time: User makes a choice to enter the LiveTime Application.

108—Are You a Member ? User makes a choice to initiate membership with LiveTime.

112—Signup: New users make a choice to sign up to the LiveTime Application, creating a plurality of users within the LiveTime environment.
116—Input Profile Data: Collection of all required data from new users to create a plurality of users. Data voluntarily provided by the user(s) through the internet and maintained by LiveTime to facilitate social interaction via friend searches, compatibility searches, and movie preferences.
124—Do You Need to Manage Your Account: User makes a choice to interact with the LiveTime server through the internet to update or maintain various social interaction and content consumption tools the user would like to access surrounding the maintenance of their profile in the LiveTime environment.
128—Do You Want to Watch a Show: User makes a choice to streaming/consume content over the internet.
132—Log Out: User makes a choice to exit the LiveTime Application environment.
136—Manage Your Account: The Home Page for LiveTime, the portal to find friends and movies and to socially interact with other users over the internet.
140—Watch a Show: User makes a choice to select which streaming content to consume/stream through the Internet.

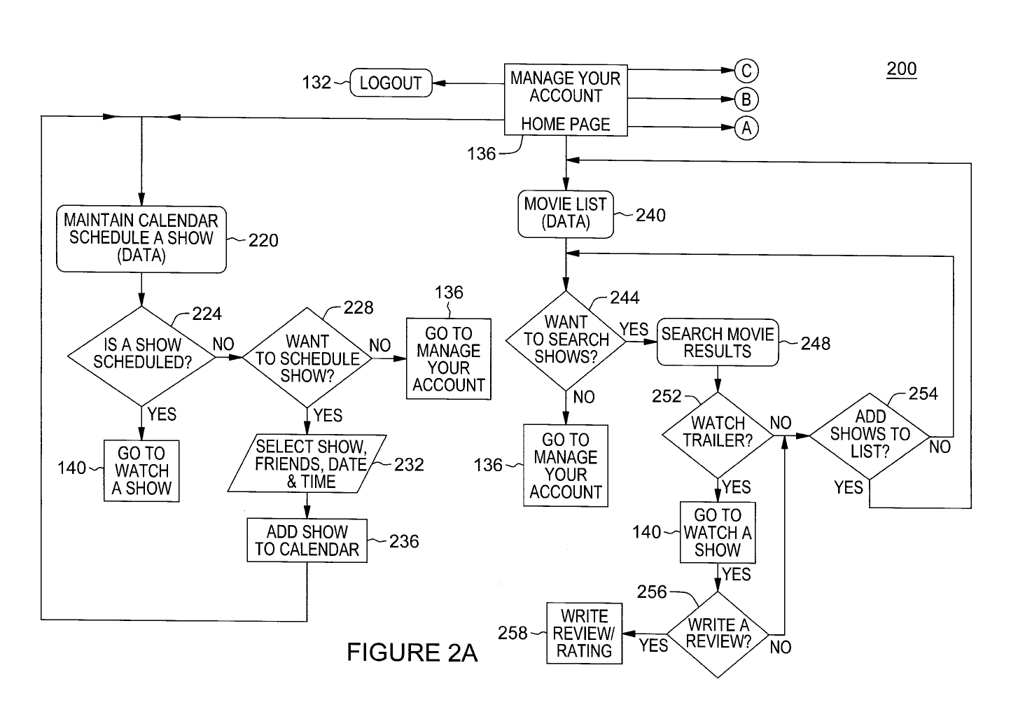

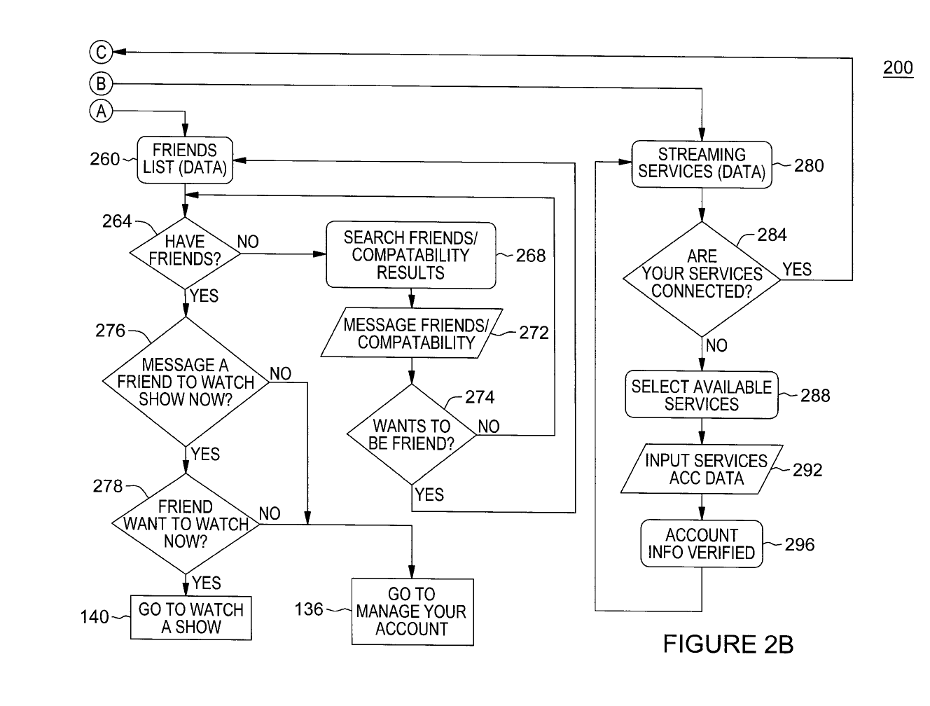

With reference to FIG. 2, an exemplary flowchart 200 for account management in accordance with an aspect of the present invention, the elements of the flowchart may be described as follows:
220—Maintain Calendar/Schedule a Show: Data collection occurs here. User coordinates content to be consumed, friends to view content with and socially connect, and date and time for consuming content into the LiveTime Calendar.
224—Is a Show Scheduled: User identifies if content is scheduled to be consumed from LiveTime calendar.
228—Want to Schedule a Show: If there are no preexisting calendar items, users makes a choice to coordinate different users/friends with content for future viewing.
232—Select Show, Friends, Date and Time: User selects friends from LiveTime Friends List, streaming content for consumption from LiveTime Movie List, and viewing date and time to consume content. User can social connect with friends to coordinate selections.
236—Add Show to Calendar: User selects streaming content to add to shared calendar for scheduled viewing between users.
240—Movie List: Data collection occurs here. LiveTime stores user's preferred streaming content for future use in scheduling and viewing content.
244—Want to Search Shows: User(s) chooses to search streaming shows, movies and live programming transmitted through the internet.
248—Search Movie Results: Search through results of previous search of streaming content.
252—Watch Trailer ? After selecting a streaming content that may be interesting, inquiry regarding the viewing of the content's trailer.
254—Add Shows to List ? Inquiry regarding streaming content search results. If user decides they'd like to consume selected content, they can add it to their Movie List for later viewing.
256—Write A Review: Post viewing of streaming content, user can choose to rate and review the featured content.
258—Write Review/Rating: User creates the content of the review/rating, creating social interaction allowing other users to learn more about the streaming content before choosing to view the content.
260—Friends List: Data collection occurs here. View existing friends list and/or add new users to your friends list.
264—Have Friends ? Inquiry regarding users connected to you via your friends list.
268—Search Friends/Compatibility Results: Search existing user list from the LiveTime server through the Internet to add new users to your friends list; or, socially connect with new users based on compatibility criteria.
272—Message Friends/Compatibility: Communicate through the Internet via the LiveTime server with existing users who you would like to add to your friends list, based on compatibility criteria or other.
274—Wants To Be Friend: If existing user also wants to socially connect with you, they are added to your friends list for future streaming.
276—Message A Friend to Watch Show Now: Communicate with an existing friend through the internet via the LiveTime server based on your friends list to coordinate mutual content streaming.
278—Friend Want to Watch Show: Does a friend from your friend list want to consume/stream a movie or show through the internet with you ?
280—Streaming Services (Data) Data collection occurs here. View and select which streaming services to connect via the LiveTime environment. Streaming services' account information is verified and/or a new account is initiated through the internet via the LiveTime server.
284—Are Your Services Connected ? Inquiry regarding which (if any) streaming services' account information is verified and are actively connected to your LiveTime account.
288—Select Available Services: User selects which streaming services they would like to connect to the LiveTime account through the Internet.
292—Input Services Account Data: User inputs the login credentials/data for the streaming services to allow LiveTime to link the service to user's LiveTime account.
296—Account Info Verified: Login credentials are verified by LiveTime through the internet. Once verified, the streaming service is connected to your LiveTime account. User is now able to view movies and television via LiveTime with any friends and users.

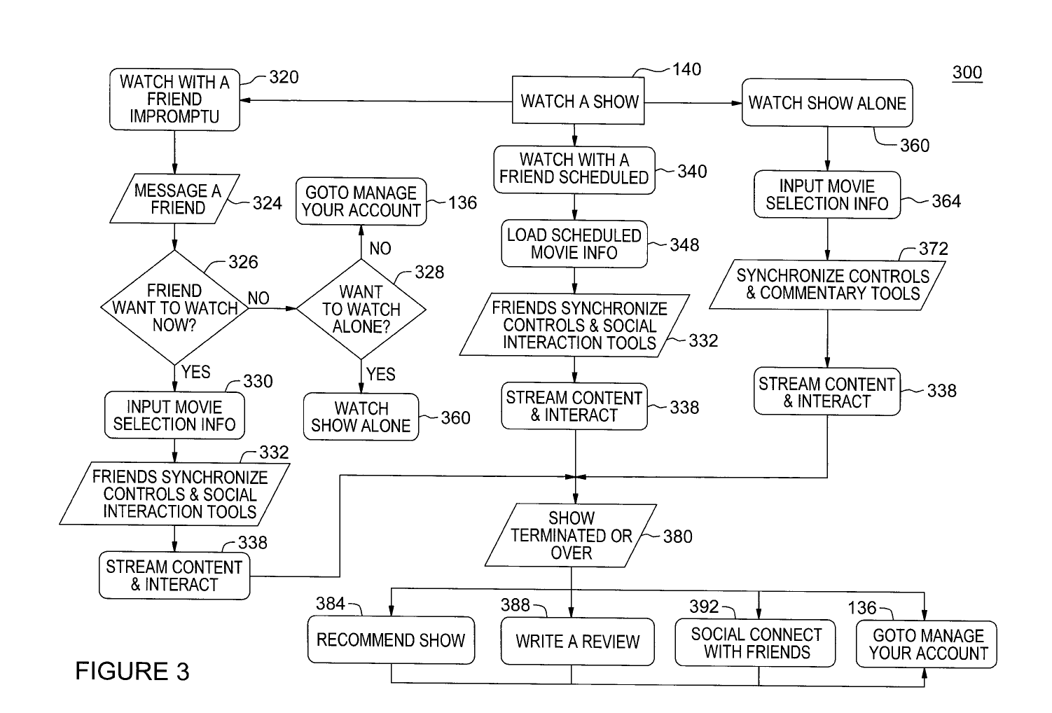

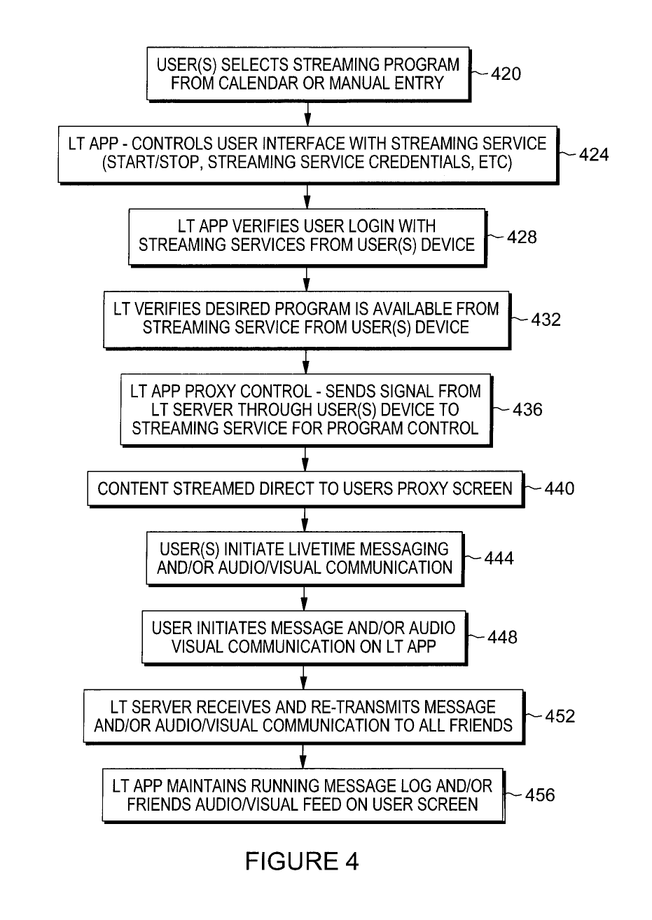

With reference to FIG. 3, an exemplary flowchart 300 for watching a show in accordance with an aspect of the present invention, the elements of the flowchart may be described as follows:
320—Watch With a Friend Impromptu: Stream content through the internet with a user from your friends list immediately, instead of a pre-scheduled a session.
324—Message A Friend: Socially communicate with a user on your friends list over the internet to consume/stream content immediately, if both users are online.
326—Friend Want to Watch Now: Socially Communicate with user on friends list includes invitation to consume/stream content immediately.
328—Want to Watch Alone: If the friend is unable to watch immediately, user has the choice to stream/consume the content alone with the option to have friends join the show in progress.
330—Input Movie Selection Info: If the friend does want to watch immediately, select the content to consume/stream from the streaming services connected to LiveTime through the internet.
332—Friends Synchronize Controls & Social Interaction Tools: Synchronize content streaming controls via the LiveTime proxy controls through the Internet and enable social interaction tools, including friends' commentary (See FIG. 4 and related discussion).
338—Stream Content and Interact: Begin streaming/consumption of content and begin connecting with your friends through the Internet.
340—Watch With a Friend Scheduled: Stream content with a user from your friends list at a pre-scheduled time via the LiveTime calendar.
348—Load Scheduled Movie Info: Load the pre-selected streaming content for consumption into the LiveTime proxy controls.
360—Watch Show Alone: Without friends available, begin streaming/consumption of content through the Internet.
372—Synchronize Controls & Commentary Tools: Synchronize content streaming controls with the LiveTime proxy controls (e.g., 332 functionality) and enable social commentary tools for consumption of content with other LiveTime users.
380—Show Terminated or Over: LiveTime proxy controls used to end content streaming (by user choice or program ends).
384—Recommend Show: As part of social interaction the user makes a choice to recommend show to other users on the friends list or to complete LiveTime user base.
388—Write a Review: As part of the social interaction the user(s) makes a choice to write a review of streaming content for future viewing by users on friends list and complete LiveTime user base.
392—Social Connect with Friends: As part of the social interaction, socially connect with friends while content is being consumed and after content consumption is terminated about ideas and other commentary on previously streamed/consumed content.

With reference to FIG. 4, an exemplary flow diagram 332, for “friends synchronize controls & social interaction tools,” in accordance with an aspect of the present invention, the elements of the flow diagram may be described as follows:
420—user(s) selects streaming program (digital content) from calendar or manual entry.
424—LiveTime app controls user interface with digital content source (e.g., streaming service/source; including start/stop, streaming service credentials, etc).
428—LiveTime app verifies user login with streaming services from user(s) device.
432—LiveTime verifies desired program is available from streaming service from user(s) device.
436—LiveTime app proxy control—sends signal from LiveTime server through user(s) device to streaming service for program control; or in an alternate embodiment directly to the content source for each user using the users credentials, to synchronize the content among all users; or a combination of these techniques.
440—content streamed direct to users proxy screen.
444—user(s) initiate LiveTime messaging and/or audio/visual communication as a social interaction tool.
448—user intiates message and/or audio visual communication on LiveTime app.
452—LiveTime server receives and re-transmits message and/or audio/visual communication to all friends.
456—LiveTime app maintains running message log and/or friends audio/visual feed on user screen.

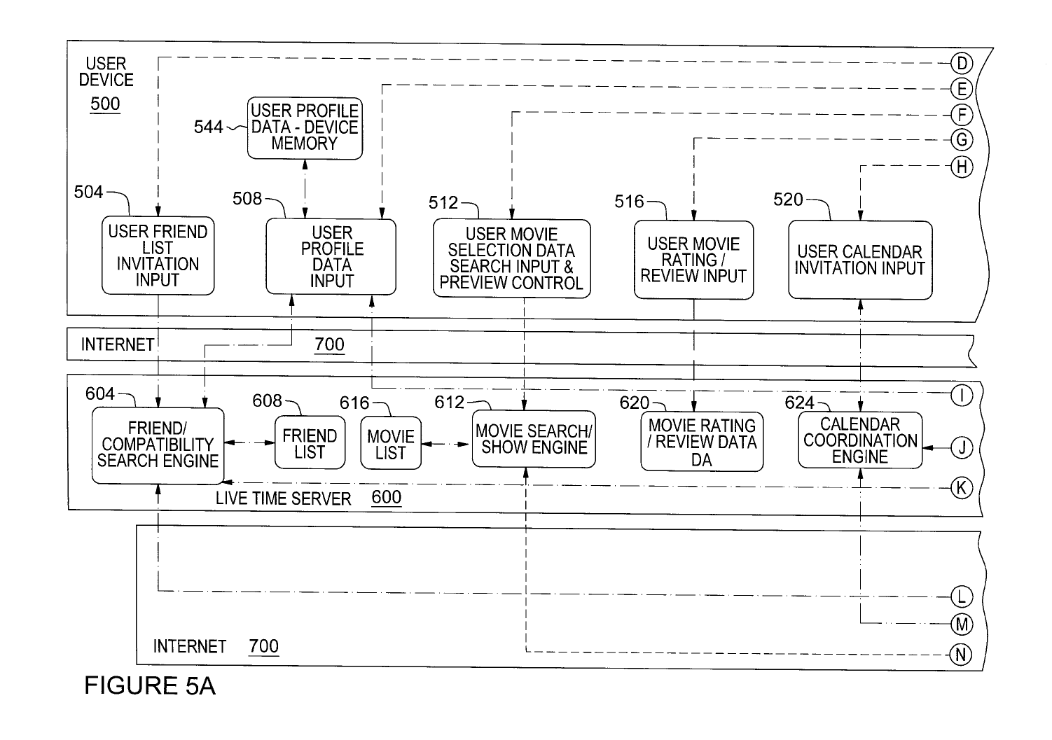

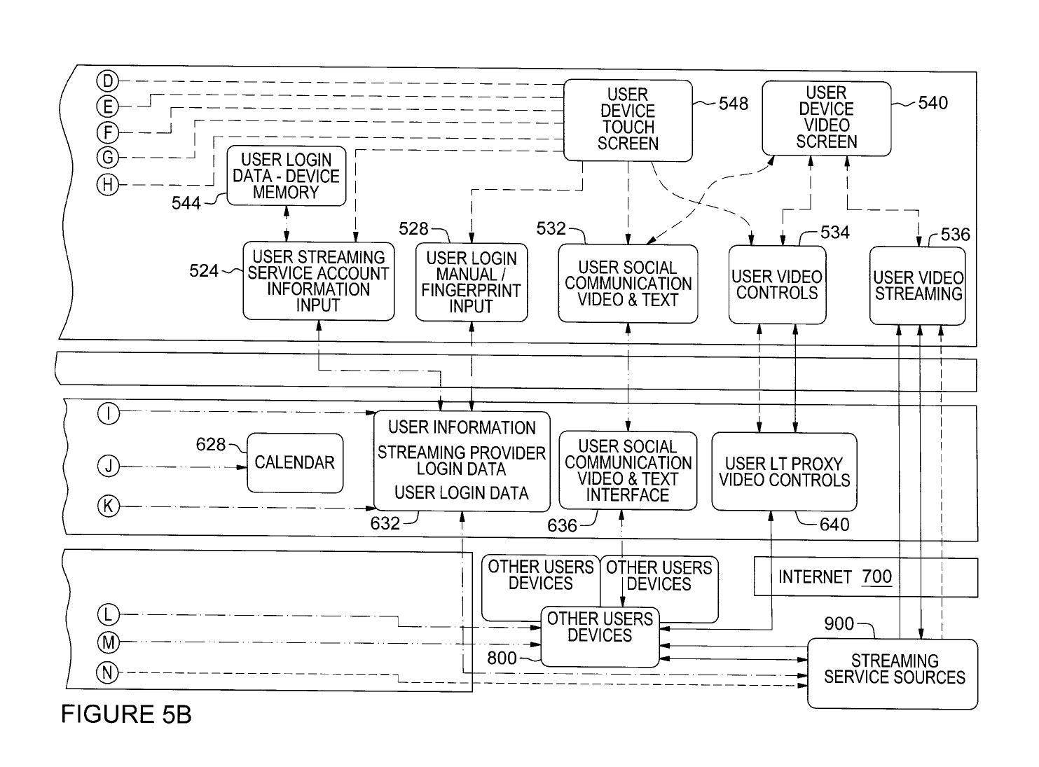

With reference to FIG. 5, an exemplary data structure and flow diagram in accordance with an aspect of the present invention including a user device 500, server 600 and internet 700 in accordance with an aspect of the present invention, the elements of the diagram may be described as follows:
500—User Device: This represents any device that can be connected and interact with internet including but not limited to cell phones, laptops, tablets and smart tv's.
504—Input Point—User's Friends Invitation: Communication of inputs over the internet from the touchscreen component or keyboard of user's device to the LiveTime Server for development of a friends list creating a plurality of users.
508—Input Point—User's Profile Data: Communication of inputs over the internet from the touchscreen component or keyboard of user's device to the LiveTime Server to input user's profile data. User's profile data to be stored on the LiveTime Server and utilized to create a plurality of users.
512—Input Point—Movie Selection and Preview: Communication of inputs over the internet from the touchscreen component or keyboard of user's device to the LiveTime Server to input user's movie selection and preview information. User's movie list data to be stored on the LiveTime Server.
516—Input Point—Movie Review and Rating: Communication of inputs over the internet from the touchscreen component or keyboard of user's device to the LiveTime Server to input user's review commentary of a movie or showing or overall rating. User's review and rating are stored on the LiveTime Server to develop an overall rating for a movie(show) for consideration by other users or friends.
520—Input Point—Calendar Input for Invitation: Communication of inputs over the internet from the touchscreen component or keyboard of user's device to the LiveTime Server to input user's invitation and movie data into LiveTime Calendar. User's calendar is maintained on LiveTime server and device memory.
524—Input Point—Streaming Service Account Information Input: Communication of inputs over the internet from the touchscreen component or keyboard of user's device to the LiveTime Server to input user's Stream Service Account information/credentials. User's account information is maintained on LiveTime server.
528—User Login Input: Communication of inputs over the internet from the touchscreen component, including fingerprint sensor or keyboard of user's device to the LiveTime Server to input user's LiveTime login information.
532—User Input of Social Interaction: Communication of inputs over the internet from the touchscreen component or keyboard of user's device to the LiveTime Server to input user's text message or commentary during consumption of content. User's inputs are viewed on the User's video display, as well as, friends viewing program.
534—User Input of Video Controls: Communication of inputs over the internet from the touchscreen component or keyboard of user's device to the LiveTime Server to input user's control of content being consumed over the internet. User's input controls effect on the User's video display as well as friends viewing program via the LiveTime proxy controls.
536—User Video Connection with Streaming Provider: Content from content provided is streamed over the internet directly to users video screen.
544—User's Device Memory: User's device onboard memory unit.
548—User's Device—Touchscreen/Input Component: User's device input component including but not limited to onboard touchscreen with optional fingerprint sensor or keyboard system.
600—LiveTime Server: This represents that LiveTime Server which includes various search engines, user data, social interaction tools and proxy video controls.
604—LiveTime Friend Search Engine: LiveTime utilizes input data from a plurality of users to locate and socially connect friends or other compatible users.
608—LiveTime Friends List: LiveTime maintains users' friends lists based on accepted friend invitation.
612—LiveTime Movie Search Engine: LiveTime utilizes input data from users to create and maintain a list of preferred viewing selections.
616—LiveTime Movie List: LiveTime maintains users' movie lists based on user selection inputs.
620—Movie Rating and Review Data: LiveTime maintains a data base of users' movie reviews and ratings for presentation to a plurality of users to assist in the user's selection of preferred movies for potential incorporation into a user's movie list.
624—LiveTime Calendar Coordination Engine: LiveTime utilizes input data from users to create and maintain a list of scheduled viewing selections.
628—LiveTime Calendar: LiveTime maintains users' scheduled movie selection.
636—LiveTime Social Communication Interface: LiveTime accepts and transmits over the internet commentary (Chat) and video display between users during the viewing of a movie or program.
640—LiveTime Video Proxy Controls: LiveTime accepts and transmits over the internet users' input that control the start, stop, rewind or fast forward of a movie program for all users simultaneously viewing a movie.
800—Plurality of Users.
900—Streaming Content Service Providers, described above. These may be the same service for all users, or different respective services.

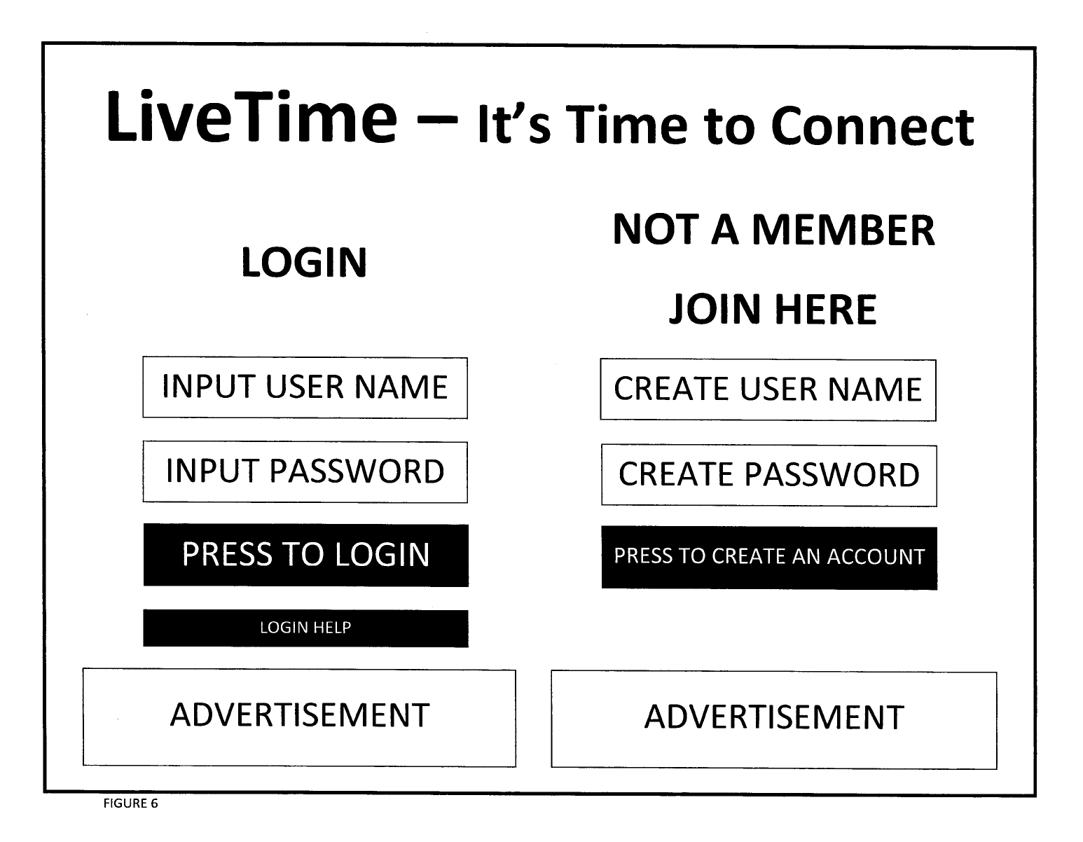

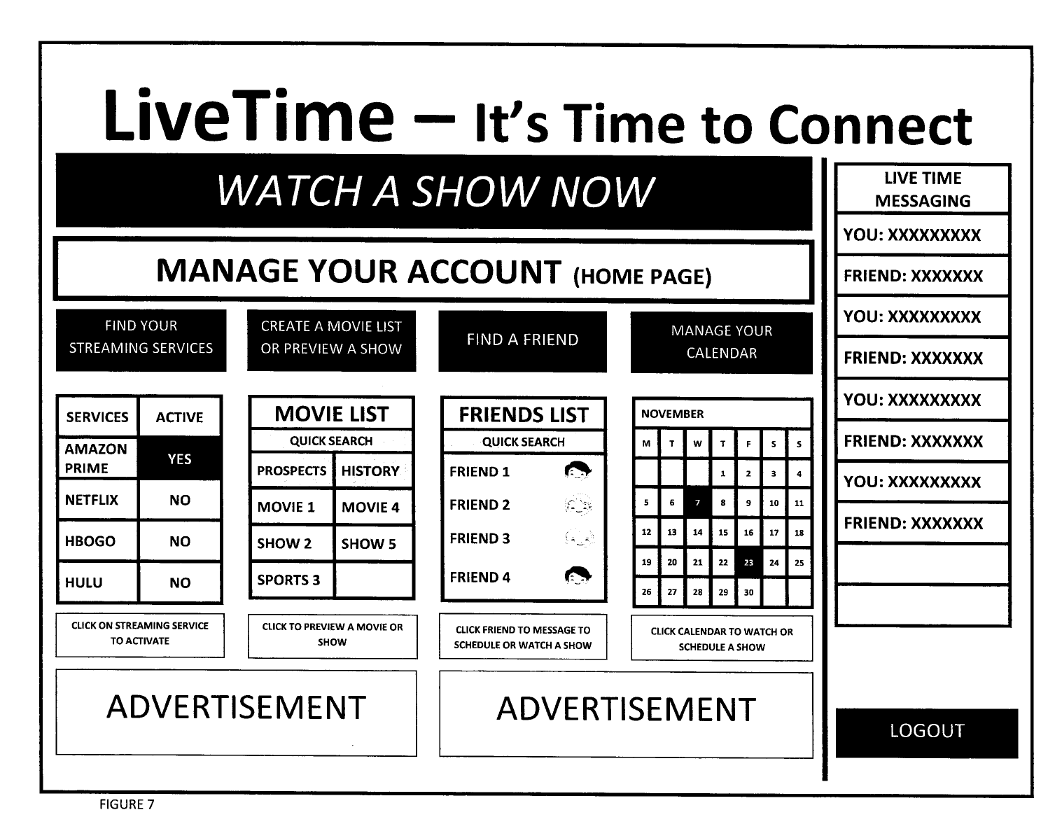

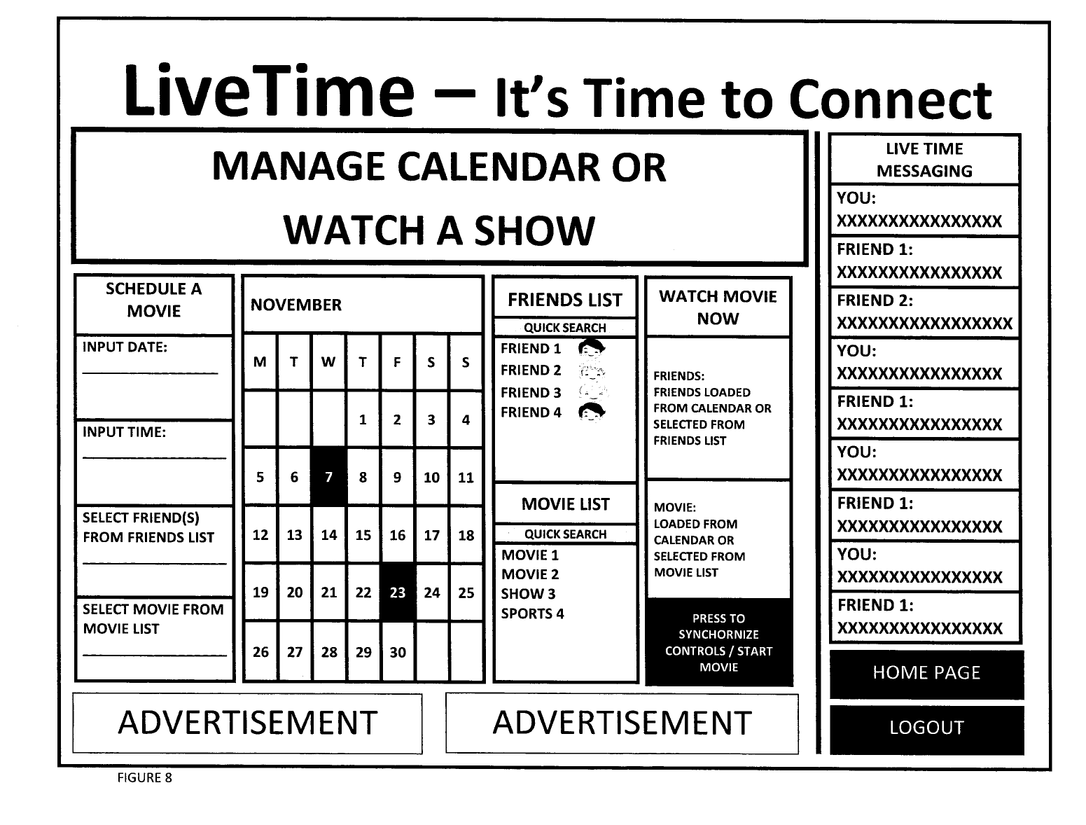

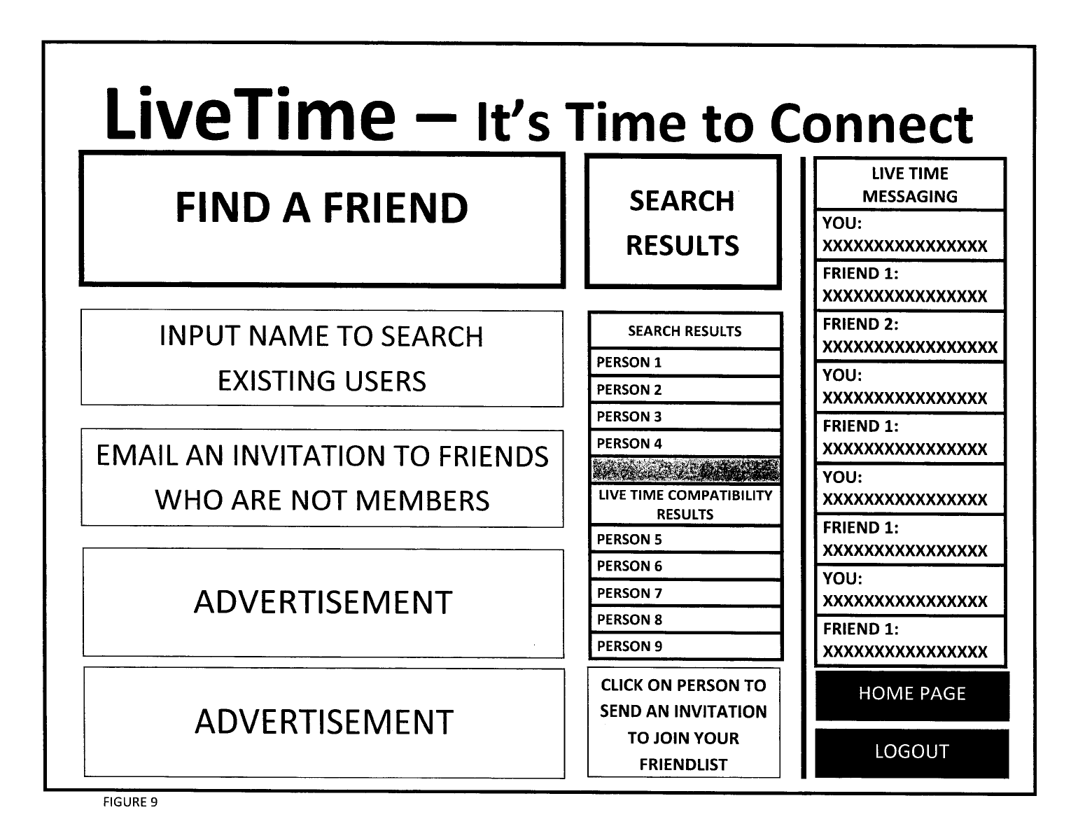

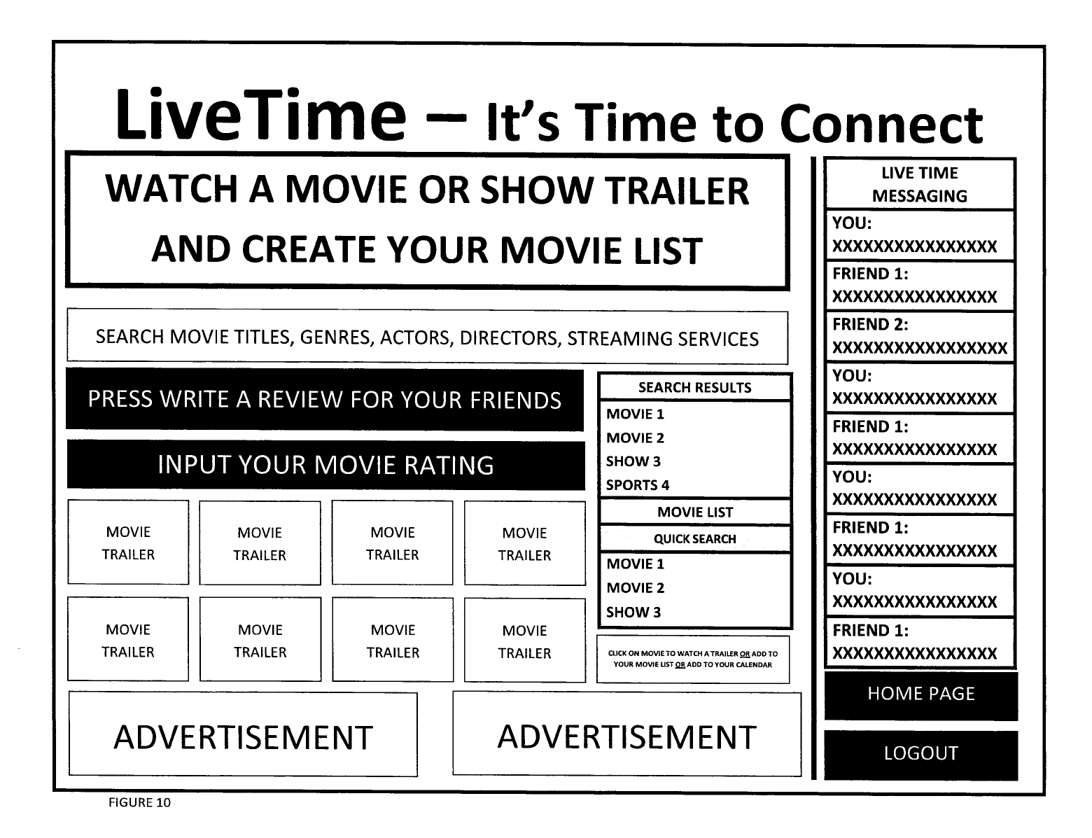

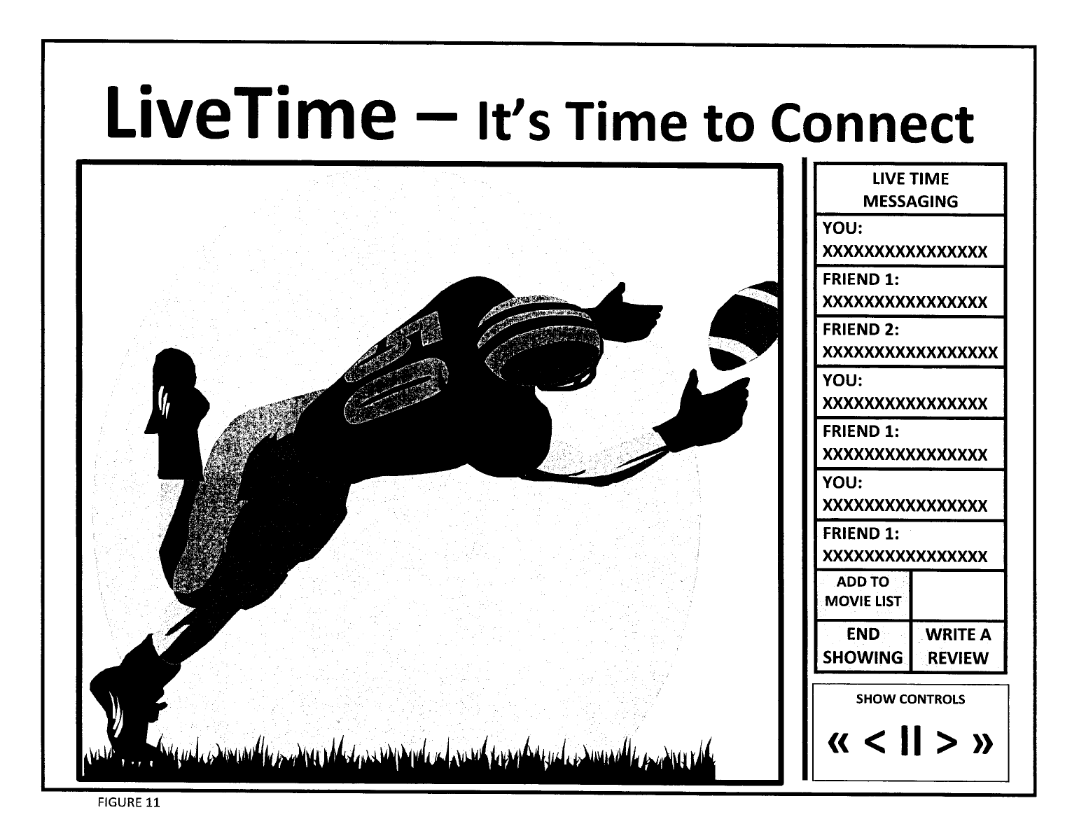

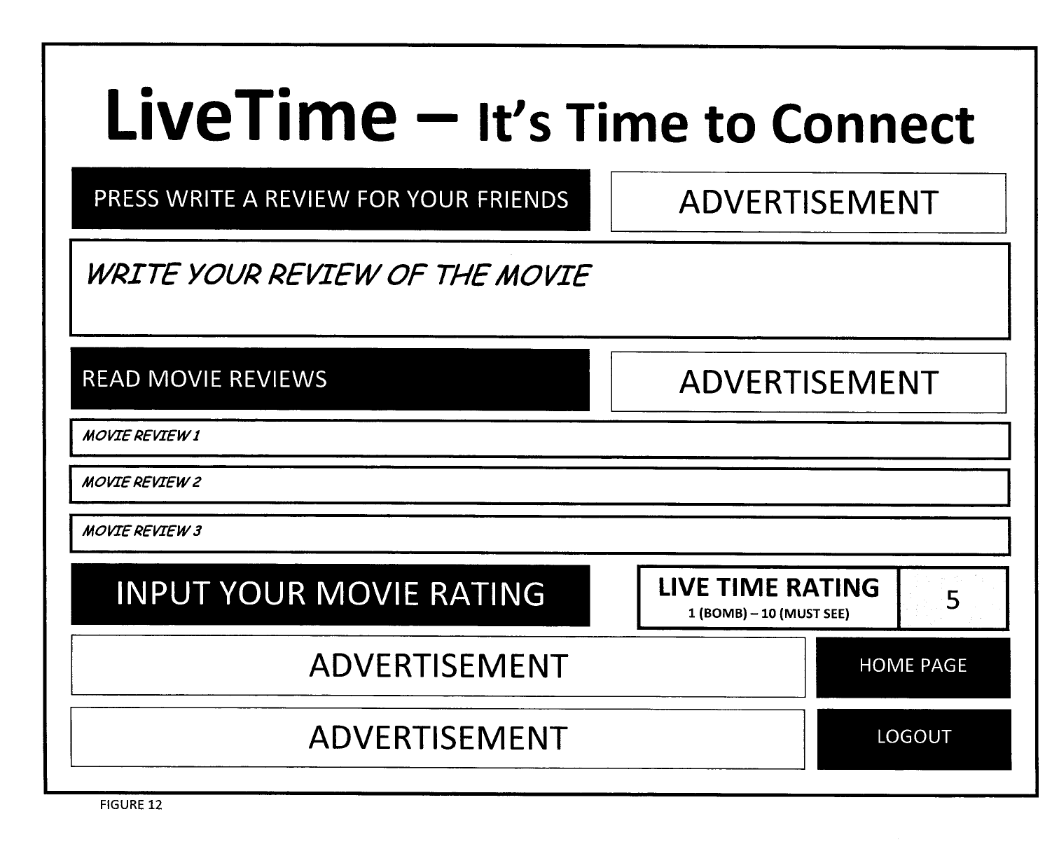

FIGS. 6-12 are exemplary screen displays, in accordance with aspects of the present invention, including connecting, watching a show, managing an account and calendar, finding friends; any or all of which may include advertising for revenue generation purposes.

As will be appreciated by one skilled in the art, control aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, control aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may be any non-transitory computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more computer readable storage media to store computer readable program code means or logic thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out control and/or calibration operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of methods, apparatus (systems) and computer program products according to embodiments of the invention. It will be understood that the control block of the diagram can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagram in the figure illustrates the architecture, functionality, and operation of possible implementations of systems, methods and computer program products according to various embodiments of the present invention. In this regard, one or more blocks in the diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that one or more blocks of the diagram can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Although various embodiments are described above, these are only examples. For example, computing environments of other architectures can incorporate and use one or more aspects of the present invention. Additionally, the network of nodes can include additional nodes, and the nodes can be the same or different from those described herein. Also, many types of communications interfaces may be used.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of the invention and the practical application, and to enable others of ordinary skill in the art to understand the invention through various embodiments and the various modifications thereto which are dependent on the particular use contemplated.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of consuming digital content among a plurality of users, comprising:
allowing the plurality of users to select the digital content to be consumed;
establishing a social interaction tool among the users over a computer network; and
allowing each user of the plurality of users to consume the selected digital content from a respective digital content stream source in substantial synchronicity over the network, including interacting with other users using the social interaction tool.

2. The method of claim 1, further comprising:
controlling said selected digital content from each content stream source, including synchronizing the consumption of said selected digital content among the plurality of users.

3. The method of claim 1, further comprising:
coordinating said plurality of users in a calendar to schedule said consuming of the selected digital content.

4. The method of claim 1, further comprising:
initially establishing the plurality of users, including using a network friends list and/or searching users on the computer network and/or identifying users from the computer network using compatibility criteria.

5. The method of claim 1, further comprising:
at least one of the plurality of users issuing a review of the selected digital content after said consuming.

6. A system for consuming digital content among a plurality of users, comprising:
means for the plurality of users selecting the digital content to be consumed;
a social interaction tool established among the users over a computer network; and
wherein each user of the plurality of users consumes the selected digital content from a respective digital content stream source in substantial synchronicity over the network, including interacting with other users using the social interaction tool.

7. The system of claim 6 controlling said selected digital content from each content stream source, including synchronizing the consumption of said selected digital content among the plurality of users.

8. The system of claim 6 coordinating said plurality of users in a calendar to schedule said consuming of the selected digital content.

9. The system of claim 6 initially establishing the plurality of users, including using a network friends list and/or searching users on the computer network and/or identifying users from the computer network using compatibility criteria.

10. The system of claim 6, further comprising:
means for at least one of the plurality of users issuing a review of the selected digital content after said consuming.

11. A computer program product for consuming digital content among a plurality of users, comprising:
a computer readable storage medium having program instructions embodied therewith, the program instructions being executable by a processor to cause the processor to perform a method comprising:
allowing the plurality of users to select the digital content to be consumed;
establishing a social interaction tool among the users over a computer network; and
allowing each user of the plurality of users to consume the selected digital content from a respective digital content stream source in substantial synchronicity over the network, including interacting with other users using the social interaction tool.

12. The computer program product of claim 11, further comprising:
controlling said selected digital content from each content stream source, including synchronizing the consumption of said selected digital content among the plurality of users.

13. The computer program product of claim 11, further comprising:
coordinating said plurality of users in a calendar to schedule said consuming of the selected digital content.

14. The computer program product of claim 11, further comprising:
initially establishing the plurality of users, including using a network friends list and/or searching users on the computer network and/or identifying users from the computer network using compatibility criteria.

15. The computer program product of claim 11, further comprising:
at least one of the plurality of users issuing a review of the selected digital content after said consuming.
